(19) United States
(12) Patent Application Publication
(10) Pub. No.: US 2024/0341490 A1
(43) Pub. Date: Oct. 17, 2024

(54) BED SLATS FIXING STRUCTURE

(71) Applicant: Xusheng CHEN, Fujian (CN)

(72) Inventor: Xusheng CHEN, Fujian (CN)

(21) Appl. No.: 18/757,526

(22) Filed: Jun. 28, 2024

(30) Foreign Application Priority Data
Mar. 29, 2024 (CN) 2024103754786

(51) Int. Cl. A47C 19/02; A47C 19/00; A47C 19/20

(52) U.S. Cl. CPC A47C 19/025; A47C 19/005; A47C 19/207

(57) ABSTRACT

A bed slats fixing structure, including two bed side rails, a plurality of mounting bases, and a plurality of bed slats; a plurality of mounting holes are formed on each of the two bed side rails; the plurality of mounting bases are connected to the plurality of mounting holes respectively; each mounting base is provided with a slot and a resilient arm located at one end of the slot; a fixed end of the resilient arm is connected to the mounting base, and a free end of the resilient arm is movably located at said one end of the slot; each of two ends of each of the plurality of bed slats is provided with an insertion part; each insertion part is inserted into the slot of a corresponding mounting base and restricted by the resilient arm of the corresponding mounting base from moving leftward or rightward in the slot.

### BACKGROUND OF THE INVENTION

The present invention relates to the technical field of furniture, and in particular to a bed slats fixing structure.

One of the indispensable furniture in people's lives is the bed, which is large and bulky. Therefore, manufacturers need to break down bed frames or related products into smaller assemblies or individual pieces, and then reassemble them after delivery. Therefore, connection structures between various parts become particularly important. Products having connection structures which can achieve connections more easily and firmly are more favored by users.

In the prior art, there are usually two types of connection structures between a bed slat and a corresponding bed side rail: a first type involves assembling with corner connector, which requires a plurality of screws for locking and fixing, making the assembly process cumbersome, laborious, and inefficient; a second type involves snap-fit connection, which is relatively convenient for assembling the bed slat and the corresponding bed side rail, but its structural strength is greatly reduced because the effective connection point is focused only at the snap-fitting point. Moreover, since the snap-fitting point is a rigid connection between the bed slat and the corresponding bed side rail, such connection tends to produce noise when the bed frame shakes or wobbles, thus resulting in poor user's experience. It can be seen that neither of the above two connection structures can simultaneously achieve the convenience of assembly and structural strength.

### BRIEF SUMMARY OF THE INVENTION

It is an object of the present invention is to provide a bed slats fixing structure to address the problems existing in the prior art. The present invention enables quick assembly and disassembly of bed slats while maintaining structural stability.

To attain the above object, the present invention provides the following technical solutions:

A bed slats fixing structure, comprising two bed side rails, a plurality of mounting bases, and a plurality of bed slats; a plurality of mounting holes are formed on each of the two bed side rails; the plurality of mounting bases are connected to the plurality of mounting holes respectively; each of the plurality of mounting bases is provided with a slot and a resilient arm located at one end of the slot; a fixed end of the resilient arm is integrally connected to the mounting base, and a free end of the resilient arm is movably located at said one end of the slot; each of two ends of each of the plurality of bed slats is provided with an insertion part; each insertion part is inserted into the slot of a corresponding mounting base and restricted by the resilient arm of the corresponding mounting base from moving leftward or rightward in the slot.

The plurality of mounting bases are made of plastic or rubber.

Each of the two bed side rails is a hollow pipe; one side of each insertion part is provided with a notch; after each insertion part is inserted into the slot of the corresponding mounting base, the notch of the insertion part faces towards another end of the slot distal from the resilient arm so that when the insertion part slides towards said another end of the slot distal from the resilient arm, the corresponding mounting base is clamped at the notch.

Preferably, a resilient tab is provided at said another end of the slot distal from the resilient arm; after the insertion part is completely installed in the slot, the resilient tab is pressed and deformed by the insertion part, and is fitted between the insertion part and an inner wall of a corresponding bed side rail.

Preferably, at least one of a front surface and a back surface of the free end of the resilient arm is provided with a protrusion protruding therefrom.

Preferably, edges of the protrusions are chamfered.

Preferably, elongated clasps are provided at an upper portion and a lower portion of a surface of each of the plurality of mounting bases facing towards a corresponding bed side rail; the elongated clasps of each mounting base clasp on an upper edge and a lower edge of a corresponding mounting hole respectively.

Preferably, the fixed end of the resilient arm is integrally connected to a bottom wall of the elongated clasp at the upper portion of the surface of a corresponding mounting base facing towards the corresponding bed side rail.

A directional indicator is provided on a surface of each of the plurality of mounting bases facing away from the corresponding bed side rail.

According to the above technical solutions, the presenet invention has the following technical effects:
when applying the structure of the present invention to a bed frame, since the two bed side rails are provided on two sides of the bed frame respectively, and the plurality of mounting bases are mounted on each of the two bed side rails, when the insertion part of one end of each of the plurality of bed slats presses against the resilient arm of a corresponding mounting seat of one of the two bed side rails and holds this position such that the free end of the resilient arm is pressed to move out of the corresponding mounting seat and the insertion part thus being inserted into the corresponding mounting seat of said one of the two bed side rails, the insertion part of another end of each of the plurality of bed slats can also press against the resilient arm of a corresponding mounting seat of another one of the two bed side rails such that the free end of the resilient arm is pressed to move out of the corresponding seat and the insertion part thus being inserted into the corresponding seat of said another one of the two bed side rails, then each of the plurality of bed slats is pushed so that the insertion parts of two ends of each of the plurality of bed slats are pushed completely to an end stroke position corresponding to ends of the slots opposite to the resilient arms, and after that the free ends of the resilient arms will reset and thus restrict the insertion parts within the slots so that the insertion parts of each of the plurality of bed slats are securely positioned within the respective slots. Therefore, the assembly process does not require any tool but only a push of each bed slat, making the operation simple and the assembly efficient. When the product according to the present invention is delivered from the factory, the plurality of mounting bases may be pre-installed on the two bed side rails, thereby saving assembly time for users.

### BRIEF DESCRIPTION OF THE DRAWINGS

FIG. 1 is a perspective view of a specific embodiment according to the present invention;

FIG. 2 is an enlarged view of area A in FIG. 1;

FIG. 3 is an exploded view of FIG. 2;

FIG. 4 is a sectional view of the structure shown in FIG. 2;

FIG. 5 is a perspective view of a mounting base according to a specific embodiment of the present invention;

FIG. 6 is a rear view of the mounting base according to a specific embodiment of the present invention; and

FIG. 7 is a sectional view along direction B-B in FIG. 6.

### DETAILED DESCRIPTION OF THE INVENTION

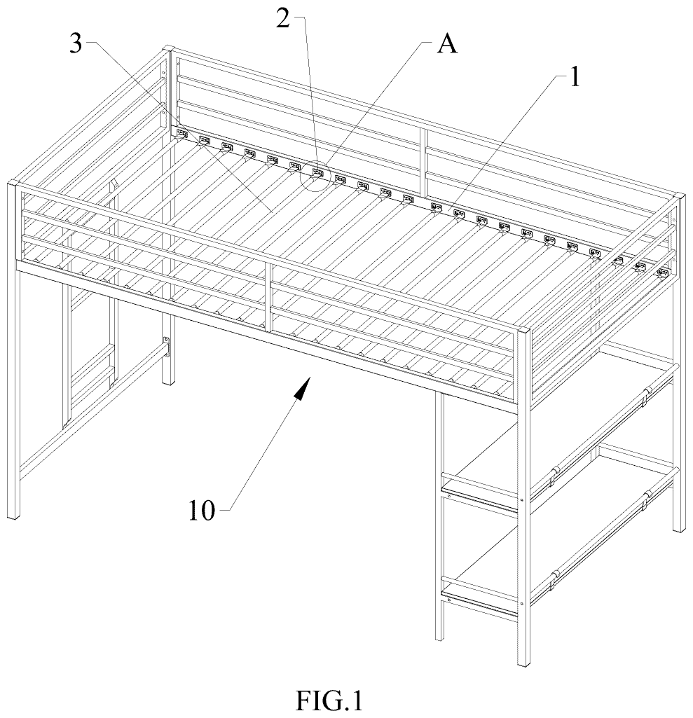

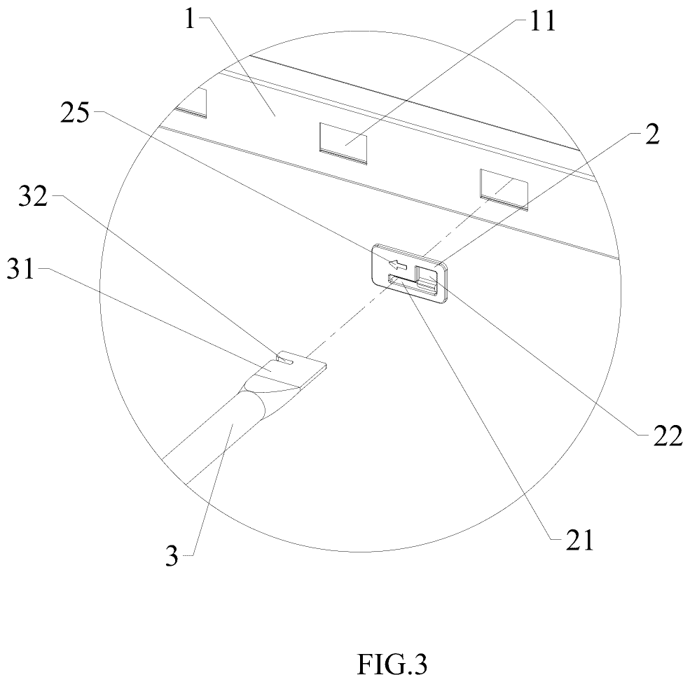

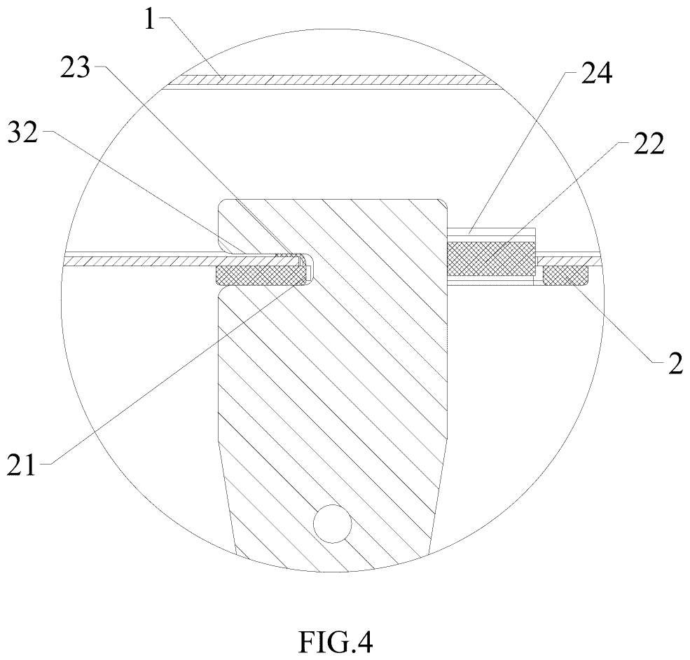

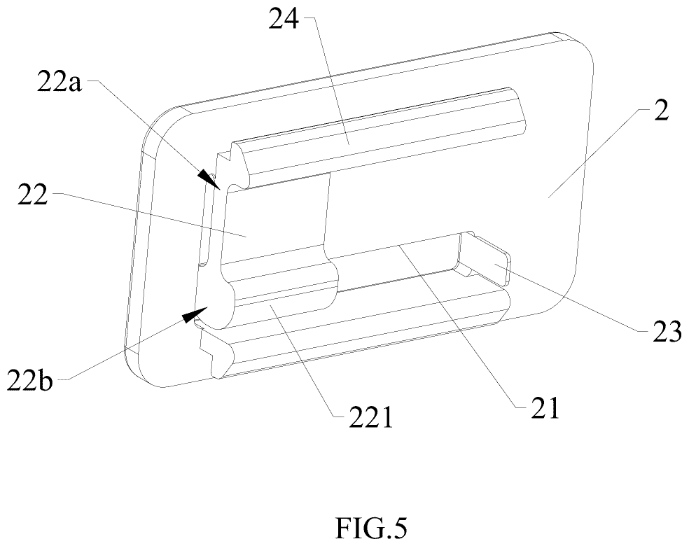

With reference to FIGS. 1 to 7, the present invention discloses a bed slats fixing structure. FIG. 1 shows that the bed slats fixing structure according to the present invention is applied to a bed frame 10. A specific form of the bed frame 10 shall not be limited by the present invention.

The bed slats fixing structure described above comprises two bed side rails 1, a plurality of mounting bases 2, and a plurality of bed slats 3.

A plurality of mounting holes 11 are formed on each of the two bed side rails 1.

The plurality of mounting bases 2 are connected to the plurality of mounting holes 11 respectively; each of the plurality of mounting bases 2 is provided with a slot 21 and a resilient arm 22 located at one end of the slot 21; a fixed end 22a of the resilient arm 22 is integrally connected to the mounting base 2, and a free end 22b of the resilient arm 22 is movably located at said one end of the slot 21; the free end 22bis capable to be pressed to move out of the slot 21.

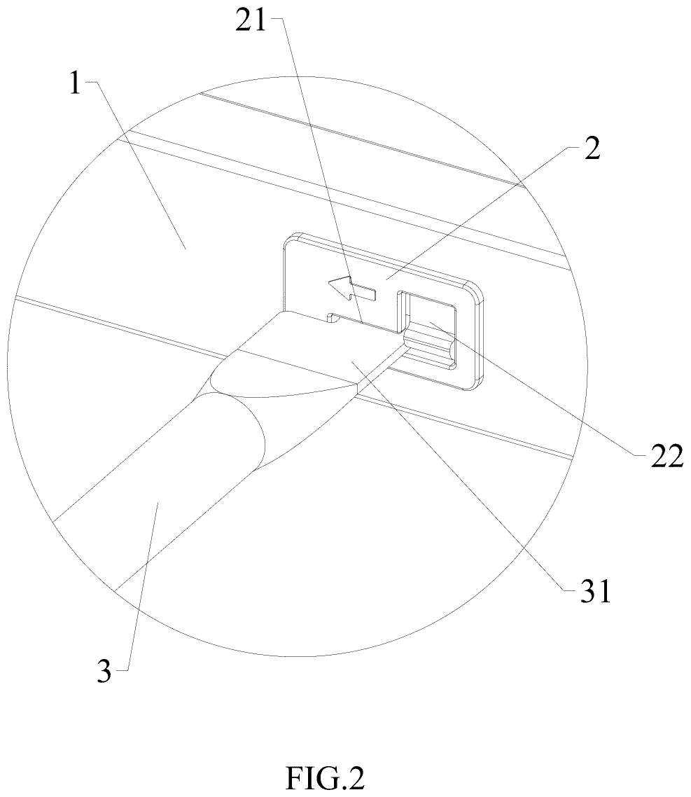

Each of two ends of each of the plurality of bed slats 3 is provided with an insertion part 31; each insertion part 31 is inserted into the slot 21 of a corresponding mounting base 2 and restricted by the resilient arm 22 of the corresponding mounting base 2 from moving leftward or rightward (leftward and rightward directions as shown in FIG. 2) in the slot 21.

According to the above technical solutions, when applying the structure of the present invention to the bed frame 10, since the two bed side rails 1 are provided on two sides of the bed frame 10 respectively, and the plurality of mounting bases 2 are mounted on each of the two bed side rails 1, when the insertion part 31 of one end of each of the plurality of bed slats 3 presses against the resilient arm 22 of a corresponding mounting seat 2 of one of the two bed side rails 1 and holds this position such that the free end of the resilient arm 22 is pressed to move out of the corresponding mounting seat 2 and the insertion part 31 thus being inserted into the corresponding mounting seat 2 of said one of the two bed side rails, the insertion part 31 of another end of each of the plurality of bed slats 3 can also press against the resilient arm 22 of a corresponding mounting seat 2 of another one of the two bed side rails 1 such that the free end of the resilient arm 22 is pressed to move out of the corresponding seat 2 and the insertion part 31 thus being inserted into the corresponding seat 2 of said another one of the two bed side rails, then each of the plurality of bed slats 3 is pushed so that the insertion parts 31 of two ends of each of the plurality of bed slats 3 are pushed completely to an end stroke position corresponding to ends of the slots 21 opposite to the resilient arms 22, and after that the free ends 22b of the resilient arms 22 will reset and thus restrict the insertion parts 31 within the slots 21 so that the insertion parts 31 of each of the plurality of bed slats 3 are securely positioned within the respective slots 21. Therefore, the assembly process does not require any tool but only a push of each bed slat 3, making the operation simple and the assembly efficient. The resilient arm 22 of each of the plurality of mounting bases 2 has a certain width (thickness) to increase a supporting force against a corresponding insertion part 31 of a corresponding bed slat 3 in the mounting base 2 along a lengthwise direction of a corresponding slot 21, and thus improving the structural strength of the mounting base 2 at said one end of the slot 21. When the product according to the present invention is delivered from the factory, the plurality of mounting bases 2 may be pre-installed on the two bed side rails 1, thereby saving assembly time for users.

The following describes the specific embodiments of the present invention.

The plurality of mounting bases 2 may be made of materials such as plastic or rubber, while the two bed side rails 1 and the plurality of bed slats 3 are generally made of metal. This can prevent the occurrence of noise caused by metal-to-metal contact, thereby achieving a silent effect and providing a better user's experience.

Each of the two bed side rails 1 is a hollow pipe; the plurality of mounting holes 11 are formed on a side surface of each of the two bed side rails 1 that connects with the plurality of bed slats 3; one side of each insertion part 31 is provided with a notch 32; after each insertion part 31 is inserted into the slot 21 of a corresponding mounting base 2, the notch 32 of the insertion part 31 faces towards another end of the slot 21 distal from the resilient arm 22 so that when the insertion part 31 slides towards said another end of the slot 21 distal from the resilient arm 22, the corresponding mounting base 2 is clamped at the notch 32, thereby forming an interlocking structure between the insertion part 31 and the corresponding mounting base 2. This can restrict the movement of the bed slats 3 along their own axial direction, thereby achieving a more secured structure that can meet the tensile strength requirements of the bed slats 3.

Furthermore, a resilient tab 23 is provided at said another end of the slot 21 distal from the resilient arm 22; after the insertion part 31 is completely installed in the slot 21, the resilient tab 23 is pressed and deformed by the insertion part 31, and is fitted between the insertion part 31 and an inner wall of a corresponding bed side rail 1, thus separating an inner wall of the notch 32 from the inner wall of the bed side rail 1. This prevents direct contact between a corresponding bed slat 3 and the corresponding bed side rail 1, thereby further enhancing the silence effect of the product.

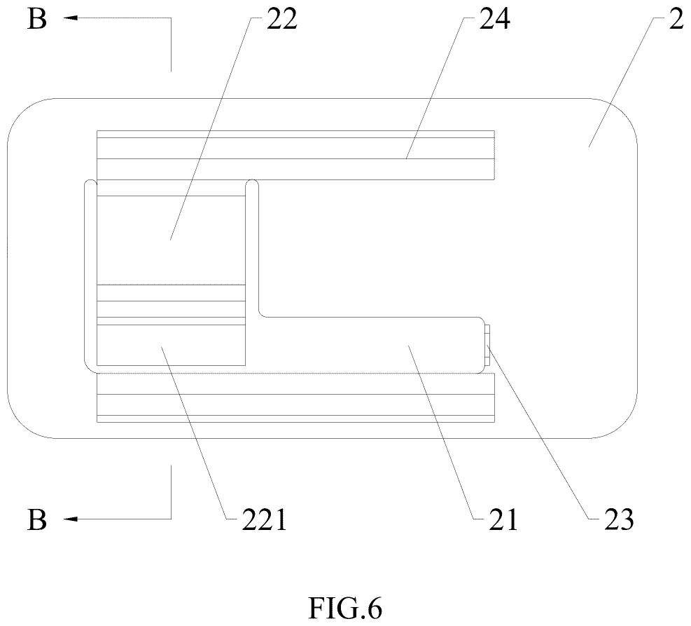

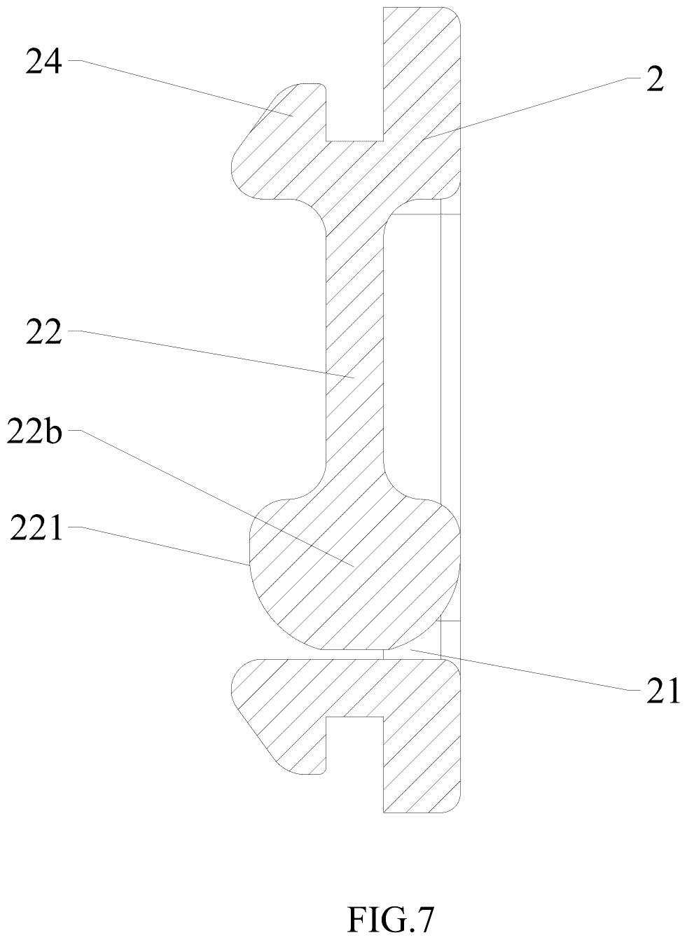

Additionally, at least one of a front surface and a back surface of the free end 22b of the resilient arm 22 is provided with a protrusion 221 protruding therefrom. The protrusion 221 can increase a thickness of the free end 22b of the resilient arm 22, thereby ensuring its limiting effect on a corresponding insertion part 31. According to an embodiment with reference to FIGS. 6 and 7, each of both the front surface and the back surface of the free end 22b of the resilient arm 22 is provided with said protrusion 221. Edges of the protrusions 221 are chamfered. Since the edges of the protrusions 221 are chamfered, when the resilient arm 22 is pressed to move out of the slot 21, the free end 22b can be more smoothly and quickly moved out of said one end of the slot 21, thereby allowing the user to remove a corresponding bed slat 3 in a more effort-saving manner.

In addition, elongated clasps 24 are provided at an upper portion and a lower portion of a surface of each of the plurality of mounting bases 2 facing towards a corresponding bed side rail 1; the elongated clasps 24 of each mounting base 2 clasp on an upper edge and a lower edge of a corresponding mounting hole 11 respectively to prevent the mounting base 2 from falling out of the mounting hole 11. According to an embodiment of the present invention with reference to FIGS. 6 and 7, the fixed end 22a of the resilient arm 22 is integrally connected to a bottom wall of the elongated clasp 24 at the upper portion of the surface of a corresponding mounting base facing towards the corresponding bed side rail 1. Since the elongated clasps 24 protrude from the surface of the corresponding mounting base 2 facing towards the corresponding bed side rail 1, the resilient arm 22 being positioned directly at the bottom wall of the elongated clasp 24 can prevent a bottom end of the resilient arm 22 (i.e., the protrusion(s) 221 of the free end 22b) from projecting out of a surface of the corresponding mounting base 2 facing away from the corresponding bed side rail 1 (i.e., an operating surface facing the user). This arrangement positions the resilient arm 22 within the confinement of the corresponding mounting base 2 when the resilient arm 22 is not pressed, making it less likely for users to accidentally activate the resilient arm 22 which may otherwise lead to the risk of disengagement of a corresponding insertion part 31 from the slot 21 of the corresponding mounting base 2.

A directional indicator 25 is provided on the surface of each of the plurality of mounting bases 2 facing away from the corresponding bed side rail 1; the directional indicator is used to indicate a mounting direction of the insertion part 31 of a corresponding bed slat 3, thereby enhancing user-friendliness.

What is claimed is:

1. A bed slats fixing structure, comprising:
two bed side rails, a plurality of mounting bases, and a plurality of bed slats;
a plurality of mounting holes are formed on each of the two bed side rails;
the plurality of mounting bases are connected to the plurality of mounting holes respectively; each of the plurality of mounting bases is provided with a slot and a resilient arm located at one end of the slot; a fixed end of the resilient arm is integrally connected to the mounting base, and a free end of the resilient arm is movably located at said one end of the slot;
each of two ends of each of the plurality of bed slats is provided with an insertion part; each insertion part is inserted into the slot of a corresponding mounting base and restricted by the resilient arm of the corresponding mounting base from moving leftward or rightward in the slot.

2. The bed slats fixing structure of claim 1, wherein the plurality of mounting bases are made of plastic or rubber.

3. The bed slats fixing structure of claim 1, wherein each of the two bed side rails is a hollow pipe; one side of each insertion part is provided with a notch; after each insertion part is inserted into the slot of the corresponding mounting base, the notch of the insertion part faces towards another end of the slot distal from the resilient arm so that when the insertion part slides towards said another end of the slot distal from the resilient arm, the corresponding mounting base is clamped at the notch.

4. The bed slats fixing structure of claim 3, wherein a resilient tab is provided at said another end of the slot distal from the resilient arm; after the insertion part is completely installed in the slot, the resilient tab is pressed and deformed by the insertion part, and is fitted between the insertion part and an inner wall of a corresponding bed side rail.

5. The bed slats fixing structure of claim 3, wherein at least one of a front surface and a back surface of the free end of the resilient arm is provided with a protrusion protruding therefrom.

6. The bed slats fixing structure of claim 5, wherein edges of each protrusion are chamfered.

7. The bed slats fixing structure of claim 3, wherein elongated clasps are provided at an upper portion and a lower portion of a surface of each of the plurality of mounting bases facing towards a corresponding bed side rail; the elongated clasps of each mounting base clasp on an upper edge and a lower edge of a corresponding mounting hole respectively.

8. The bed slats fixing structure of claim 7, wherein the fixed end of the resilient arm is integrally connected to a bottom wall of the elongated clasp at the upper portion of the surface of a corresponding mounting base facing towards the corresponding bed side rail.

9. The bed slats fixing structure of claim 1, wherein a directional indicator is provided on a surface of each of the plurality of mounting bases facing away from a corresponding bed side rail.
